(19) United States
(12) Patent Application Publication
(10) Pub. No.: US 2026/0238158 A1
(43) Pub. Date: Aug. 13, 2026

(54) e-Trailer with Solar Modules

(71) Applicant: Solaredge Technologies Ltd., Herzeliya (IL)

(72) Inventors: David Ben-Bassat, Ganey Tikva (IL); Laurent Lu, Erlangen (DE); Philipp Walther, Schweinfurt (DE); Roberto Chiacchiera, Perugia (IT); Ruben Petroni, Città di Castello (IT); Radenko Prnja, Vienna (AT)

(21) Appl. No.: 19/333,595

(22) Filed: Sep. 19, 2025

Related U.S. Application Data
(63) Continuation-in-part of application No. 19/211,737, filed on May 19, 2025.
(60) Provisional application No. 63/649,593, filed on May 20, 2024.
(60) Provisional application No. 63/652,772, filed on May 29, 2024.

(51) Int. Cl. H02S 20/30; B60K 16/00; B60P 3/00; H02S 40/42

(52) U.S. Cl. CPC H02S 20/30; H02S 40/425; B60K 16/00; B60K 2016/003; B60P 3/00

(57) ABSTRACT

A surface comprising photovoltaic panels attached to the surface using various techniques. The surface may be a flexible surface or a rigid surface. The surface may comprise one or more pockets for inserting corresponding one or more photovoltaic panels into the corresponding pockets. The photovoltaic panels may be attached to the surface with an overlap between photovoltaic panels. A cooling plate may be attached between the surface and the photovoltaic panel, allowing air to flow between the surface and he photovoltaic. The surface may comprise a 3-sided slotted frame. The surface may comprise strip-lining attached between two adjacent photovoltaic panels. The surface may comprise securing rings for tying the photovoltaic panels to the surface.

### CROSS REFERENCE TO RELATED APPLICATIONS

This patent application claims priority to and is a continuation-in-part of U.S. application Ser. No. 19/211,737, filed May 19, 2025, and also claims the benefit of U.S. Provisional Patent Application No. 63/652,772, filed May 29, 2024, entitled “Methods For Attaching a Photovoltaic Panel to a Surface,” and U.S. Provisional Patent Application No. 63/649,593, filed May 20, 2024, entitled “Modular Trailer.” The disclosures of U.S. Provisional Patent Application No. 63/652,772 and U.S. Provisional Patent Application No. 63/649,593 are hereby incorporated by reference in their entirety.

### FIELD OF THE DISCLOSURE

The disclosure relates generally to photovoltaic panels. More specifically, the disclosure provides systems and methods for affixing a photovoltaic panel to surfaces which may be made of various materials such as fabric, aluminum, or steel.

### BACKGROUND OF THE DISCLOSURE

Photovoltaic panels may be used to produce power from the sun. Attaching such photovoltaic panels to surfaces may be a challenge.

### BRIEF SUMMARY OF THE DISCLOSURE

The following presents a simplified summary of the disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

A surface may comprise photovoltaic panels attached to the surface. The surface may be a flexible surface (e.g., made from fabric), and the photovoltaic panels may be attached to the photovoltaic panel by sewing, welding, hook and loop, zippers, adhesive, belts, or speed tape. The surface may be a rigid surface, and the photovoltaic panels may be attached to the photovoltaic panel by, screws, bolts, rivets, welding, belts, adhesive, or speed tape.

The surface may comprise one or more pockets for inserting corresponding one or more photovoltaic panels into the corresponding pockets.

The photovoltaic panels may be attached to the surface with an overlap between photovoltaic panels.

A cooling plate may be attached between the surface and the photovoltaic panel, which may allow air to flow between the surface and he photovoltaic.

The surface may comprise a 3-sided slotted frame, wherein the photovoltaic panel may be inserted into the 3-sided slotted frame, and wherein a stopper may be fitted at the fourth side of the photovoltaic panel.

The surface may comprise a strip-lining attached between two adjacent photovoltaic panels.

The surface may comprise securing rings for tying the photovoltaic panels to the surface.

### BRIEF DESCRIPTION OF THE DRAWINGS

A more complete understanding of the present disclosure and the advantages thereof may be acquired by referring to the following description in consideration of the accompanying drawings, in which like reference numbers indicate like features, and wherein:

FIGS. 1A and 1B show examples of photovoltaic panels attached to a roof of a truck;

FIGS. 2A, 2B, 2C, and 2D show examples of photovoltaic panels attached to a roof of a truck;

FIG. 3, shows an example of photovoltaic panels attached to a roof of a truck;

FIG. 4 shows an example of photovoltaic panels attached to a roof of a truck;

FIGS. 5A and 5B show an example of photovoltaic panels attached to a roof of a truck;

FIGS. 6A and 6B show an example of photovoltaic panels attached to a roof of a truck;

FIG. 7 shows an example of photovoltaic panels attached to a roof of a truck; and

FIG. 8 shows an example of photovoltaic panels attached to a roof of a truck.

### DETAILED DESCRIPTION OF THE DISCLOSURE

In the following description of the various embodiments, reference is made to the accompanying drawings, which form a part hereof, and in which is shown by way of illustration various embodiments in which the disclosure may be practiced. It is to be understood that other embodiments may be utilized and structural and functional modifications may be made without departing from the scope of the present disclosure.

The disclosure herein describes various methods and systems for attaching a photovoltaic panel or panels to a surface. The surface may be a flexible surface (e.g., made from a fabric). The surface may be a rigid surface (e.g., made of wood, aluminum, or steel). The examples brought in the disclosure herein, describe methods for attaching a photovoltaic panel to a trailer (e.g., a semi-trailer or a full trailer) of a truck. A trailer of a truck may be covered by a fabric attached to a frame of the trailer. A trailer of a truck may be covered by rigid surfaces (e.g., made of aluminum) attached to the frame of the trailer. Attaching photovoltaic panels to a trailer of a truck may have the advantage of producing electrical power used by the truck. For example, such as if the truck is electrically powered using electrical motors (e.g., using batteries), the power generated by the photovoltaic panels may be used to power the motors or charge the battery or batteries. If the trailer comprises a cooled container, the power generated by the photovoltaic panels may be used to power the refrigerating unit.

One of the challenges associated with attaching a photovoltaic panel or panels to a trailer of a truck may be that, such as in cases in which the track is in motion, a velocity of the truck may create wind blowing over the roof of the truck. This wind may exert forces on photovoltaic panels attached to the roof, increasing the risk that one or more photovoltaic panels may become detached from the roof. The attachments of the photovoltaic panel to the roof of the truck may be required to withstand the forces that the wind may exert on the photovoltaic panel.

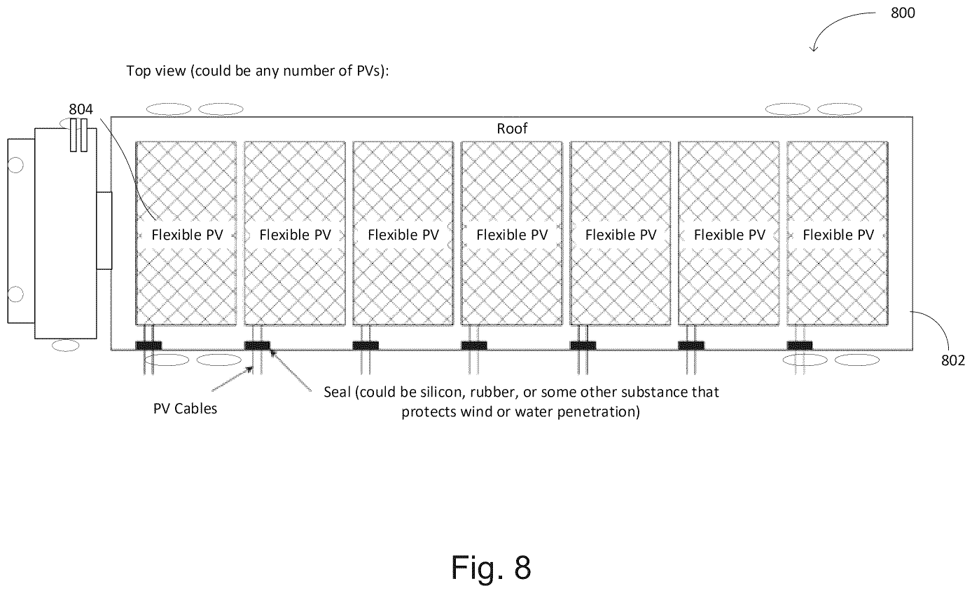

Reference is made to FIG. 8, which shows photovoltaic panels attached to a roof of a truck, generally referenced 800. FIG. 8 shows a photovoltaic panel, such as photovoltaic panel 804, attached to a surface, such as a roof 802 of a trailer of a truck. The photovoltaic panel 804 may be a hard photovoltaic panel or a flexible photovoltaic panel. The photovoltaic panels in FIG. 8 may be attached to roof 802 using various techniques. In some instances, photovoltaic panel 804 may be attached directly to the frame of the trailer (e.g., via the fabric or via the aluminum plates covering the frame), by using fasteners such as screws, bolts, or rivets.

In some instances, the trailer may comprise a mounting frame for mounting the photovoltaic the panels. Photovoltaic panel 804 may be attached using the mounting frame. The mounting frame may be attached directly to the frame of the trailer (e.g., via the fabric or via the aluminum plates covering the frame), by fasteners such as screws, bolts, or rivets. In cases in which the trailer is a container trailer, the mounting frame may be attached to the container trailer using twist locks such as may be used to lock containers to trailers or containers to other containers. The mounting frame may comprise rails for positioning and securing the photovoltaic panels.

In some instances, in cases in which the trailer comprises aluminum or steel plates covering the frame, the photovoltaic panel 804 may be attached to the aluminum or steel plates by using adhesive, by welding, by using screws, bolts, or rivets, by using magnets, or by using speed tape.

In some instances, in cases in which the trailer comprises a fabric covering the frame, Photovoltaic panel 804 may be attached to the fabric by using adhesive, by sewing, by using welding, by using Velcro, by using zippers, or by using speed tape.

In some instances, photovoltaic panel 804 may be attached to the frame of the trailer, to the fabric covering the frame, or to the aluminum of steel plates covering the frame using belts which hare attached frame, fabric, or plates.

In some instances, photovoltaic panel 804 may be attached to the fabric covering the frame, or to the aluminum of steel plates covering the frame using inserting the panels into pockets which are attached to the fabric or the covering frames.

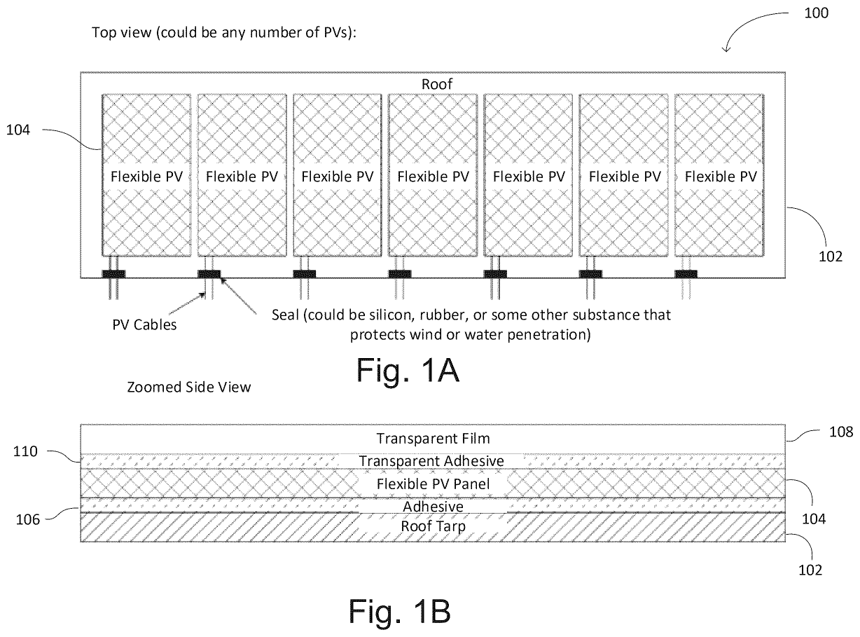

FIGS. 1A-1B, 2A-2D, 3, 4, 5A-5B, 6A-6B and 7, describe in more detail some of the examples described in conjunction with FIG. 8 as well as additional examples and details. It is noted that the examples shown in any one of FIGS. 1A-1B, 2A-2D, 3, 4, 5A-5B, 6A-6B, and 8 may be carried out by itself or in combination with other aspects described in any one of FIGS. 1A-1B, 2A-2D, 3, 4, 5A-5B, 6A-6B, 7 and 8.

Reference is made to FIGS. 1A and 1B, which show examples of photovoltaic panels attached to a roof of a truck, generally referenced 100. FIGS. 1A and 1B show a photovoltaic panel, such as photovoltaic panel 104, attached to a surface, such as a roof 102 of a trailer of a truck. FIG. 1A shows a top view of the of roof 102 and FIG. 1B shows a side view of photovoltaic panel 104 attached to roof 102. In the example shown in FIGS. 1A and 1B, roof 102 is made of a fabric. According to the disclosure here in photovoltaic panel 104 may be attached to roof 102 using an adhesive 106. A transparent film, such as transparent film 108, may be attached to photovoltaic panel 104 to protect photovoltaic panel 104 from damage (e.g., which may be caused by debris) using a transparent adhesive 110.

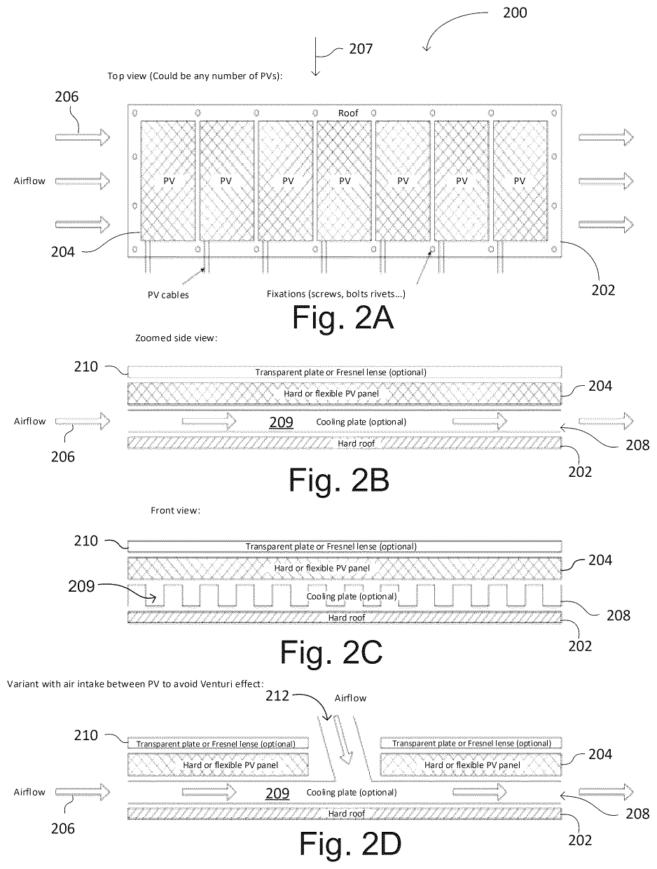

In cases in which a photovoltaic panel produces power, the photovoltaic panel may generate heat as well. In some cases, it may be required to cool the photovoltaic panel. According to the disclosure herein, a cooling plate may be placed between the surface and the photovoltaic panel. The cooling plate may comprise channels for air to flow, thus removing the heat generated by the photovoltaic panel. Reference is made to FIGS. 2A-2D, which show examples of photovoltaic panels attached to a roof of a truck, generally referenced 200. FIGS. 2A-2D show a photovoltaic panel, such as photovoltaic panel 204, attached to a surface, such as a roof 202 of a trailer of a truck. FIG. 2A shows a top view of the of roof 202, and FIGS. 2B and 2D shows a side view of photovoltaic panel 204 attached to roof 202 from the direction of arrow 207, FIG. 2C shows a side view of photovoltaic panel 204 attached to roof 202 from the direction of arrow 206.

According to the disclosure here in photovoltaic panel a cooling plate 208 maybe attached to roof 202 (e.g., using an adhesive or stickers). Photovoltaic panel 204 may be attached to cooling plate 204 (e.g., using an adhesive or stickers). A transparent film, such as transparent film 210, may be attached to photovoltaic panel 204 to protect photovoltaic panel 204 from damage. Transparent film 210 may be a transparent plate or a Fresnel lens. A shown in FIG. 2C, cooling plate 209 may comprise channels 208, which may be located between two photovoltaic panels. Channels 208 may allow air to flow between roof 202 and photovoltaic panel 204, as indicated by arrow 206, thus removing heat that may be generated by photovoltaic 204.

In some cases, the flow of air within channel 208 may cause differences in pressure along the length of channel 208 (e.g., due to the Venturi effect). To equalize the pressure along the length of channel 208, cooling plate 209 may comprise one or more air intakes, such as air intake 212, located along the of channel 208 which allow air to flow into channel 208 thus equalizing the pressure along channel 208.

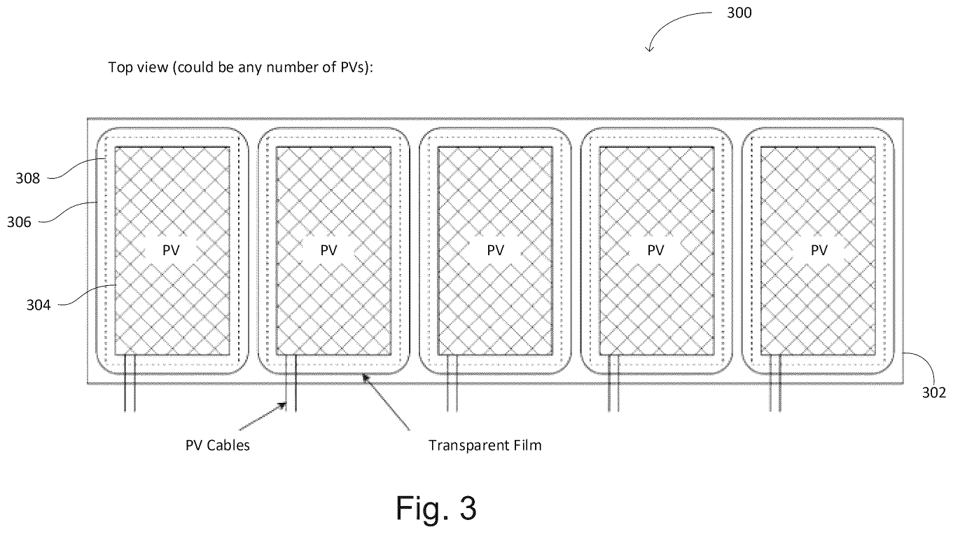

According to the disclosure herein, a pocket may be attached to the surface, and a photovoltaic panel may be inserted into the pocket. Reference is now made to FIG. 3, which shows an example of photovoltaic panels attached to a roof of a truck, generally referenced 300. FIG. 3 shows a photovoltaic panel, such as photovoltaic panel 304, attached to a surface, such as a roof 302 of a trailer of a truck. As shown in FIG. 3, a pocket, such as pocket 306, may be attached to roof 302 as indicate by dotted line 308. For example, pocket 306 may be attached to roof 302 by sewing, by welding (e.g., using ultrasonic waves, using high frequency RF waves, using hot air), by using adhesive, by using stickers, by using screws, by using rivets, by using a zipper, or by using hook and loop. Pocket 306 may comprise a transparent film to protect photovoltaic panel 304 from damage. Photovoltaic panel 304 may be inserted into pocket 306. Pocket 306 may be attached to roof 302 at any stage (e.g. during the manufacturing of roof 302 or after the manufacturing of roof 302).

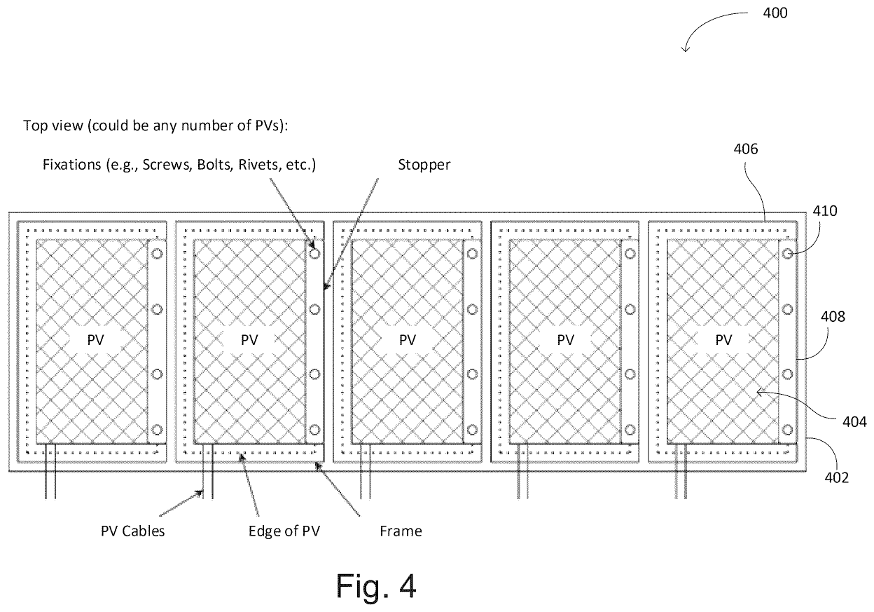

According to the disclosure herein, a photovoltaic panel may be attached to a surface such as a roof of a trailer of a truck using a frame, such as a 3-sided slotted frame into which the photovoltaic panel may be inserted. Once the photovoltaic panel is inserted into the 3-sided slotted frame, the fourth side of the photovoltaic panel will be fitted with a stopper (e.g., to prevent the photovoltaic from sliding out of the 3-sided slotted frame). Reference is now made to FIG. 4, which may show photovoltaic panels attached to a roof of a truck, generally referenced 400. FIG. 4 shows a photovoltaic panel, such as photovoltaic panel 404, attached to a surface, such as a roof 402 of a trailer of a truck. A 3-sided slotted frame 406 may be attached to roof 402 (e.g., by sewing, by welding, by using adhesive, by using stickers, by using screws, by using rivets, by using magnets, and/or by using hook and loop). Photovoltaic 404 may be inserted into 3-sided frame 406. A stopper 408 may be fitted at the fourth side of photovoltaic panel 404. Stopper 408 may prevent the photovoltaic from sliding out of the 3-sided slotted frame and/or may prevent wind from exerting forces on photovoltaic panel 404. Stopper 408 may be attached to roof 402 using fasteners such as fasteners 410. For example, fasteners 410 may be screws, bolts, or rivets. Stopper 408 may be attached to roof 402 by sewing, by welding, by using adhesive, by using stickers, by using magnets, and/or by using hook and loop. The 3-sided slotted frame 406 may be attached to roof 402 at any stage (e.g. during the manufacturing of roof 402 or after the manufacturing of roof 402). Similarly, photovoltaic panel 404 and stopper 408 may be attached to roof 402 at any stage.

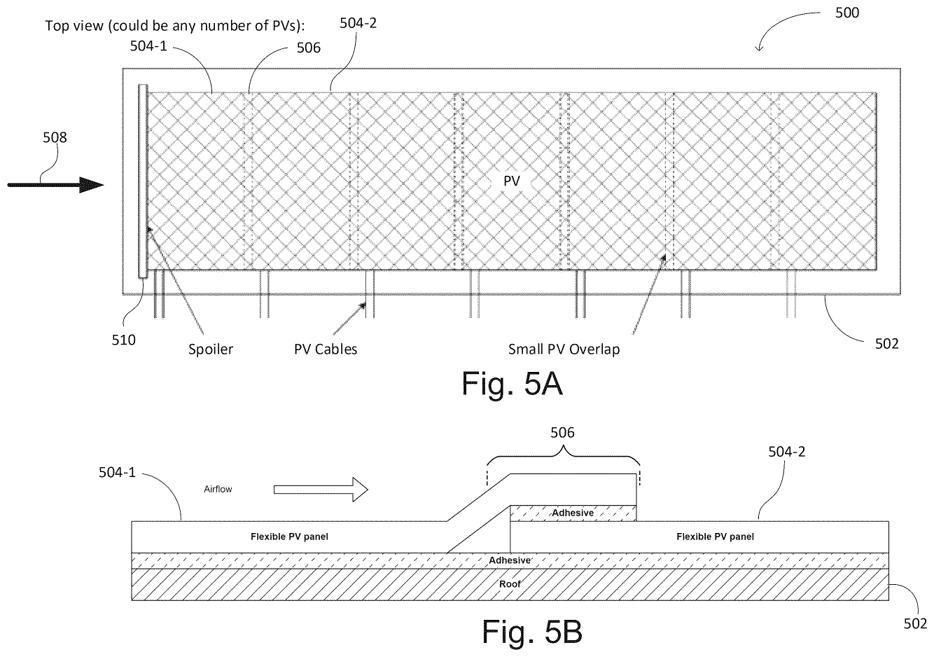

As may be described above, the attachment of the photovoltaic panel to the roof of the truck may be required to withstand the forces that wind may exert on the photovoltaic panel. In some cases, it may be beneficial to reduce the effects of the wind on the photovoltaic panels. According to the disclosure herein, photovoltaic panels may be attached to a surface with an overlap between photovoltaic panels. Reference is now made to FIGS. 5A and 5B, which may show photovoltaic panels attached to a roof of a truck, generally referenced 500. FIG. 5A shows a top view of the photovoltaic panels, such as photovoltaic panel 504-1 and photovoltaic panel 504-2, attached to roof 502, and FIG. 5B shows a side view of photovoltaic panel 504-1 and photovoltaic panel 504-2 attached to roof 502. FIGS. 5A and 5B show photovoltaic panels, such as photovoltaic panel 504-1 and photovoltaic panel 504-2, attached to a surface, such as a roof 502 of a trailer of a truck, using adhesive. When the truck is in motion, wind may blow over roof 502, as indicated by arrow 508. The blowing wind may exert forces on the photovoltaic panels, such as photovoltaic panel 504-1 and photovoltaic panel 504-2, increasing the risk that one or more photovoltaic panel may become detached from roof 502. To reduce such a risk, the photovoltaic panels may be attached with an overlap, such as overlap 506, between the photovoltaic panels, where an edge of one panel is placed on top of an edge of another panel. For example, as shown in FIGS. 5A and 5B, photovoltaic panel 504-1 is attached to roof 502 such that the edge in a downwind direction of photovoltaic panel 504-1 is placed above an edge in an upwind direction of photovoltaic panel 504-2, creating an overlap 506 between the two panels. A wind spoiler, such as wind spoiler 510, may be attached the edge in the upwind direction of the first panel in the upwind direction to reduce the forces exerted by the wind on this first panel.

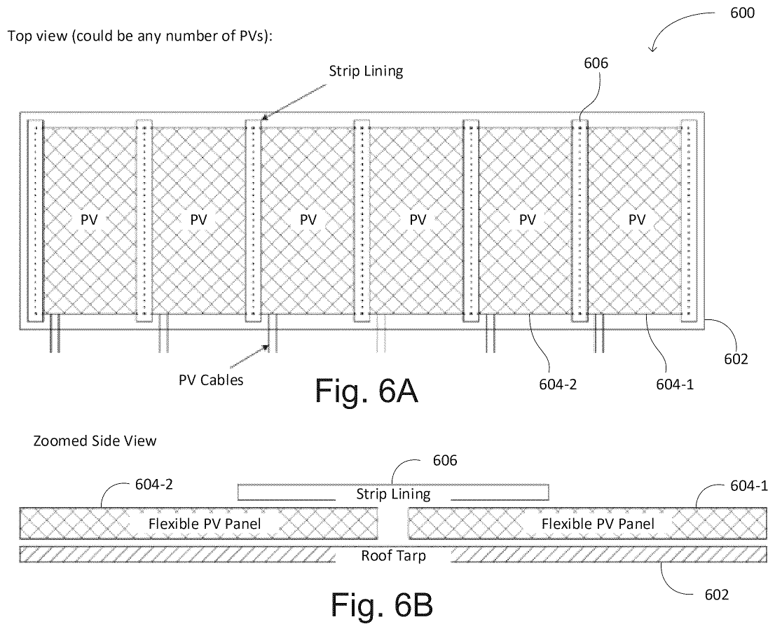

According to the disclosure herein, to reduce the effects of the wind on the photovoltaic panels, strip-linings may be attached, between the photovoltaic panels, and to the roof of the truck and/or the photovoltaic panels. Reference is now made to FIGS. 6A and 6B, which may show photovoltaic panels attached to a roof of a truck, generally referenced 600. FIGS. 6A and 6B show photovoltaic panels, such as photovoltaic panel 604-1 and photovoltaic panel 604-2, attached to a surface, such as a roof 602 of a trailer of a truck. FIG. 6A shows a top view of the of roof 602, and FIG. 6B shows a side view of photovoltaic panels 604-1 and photovoltaic panel 604-2 attached to roof 602. Photovoltaic panel 604-1 and photovoltaic panel 604-2 may be attached to a surface, such as a roof 602 of a trailer of a truck by sewing, by welding, by using adhesive, by using stickers, by using screws, by using rivets, by using magnets, or by using hook and loop. A strip-lining, such as strip-lining 606, may be attached between two adjacent photovoltaic panels, such as photovoltaic panel 604-1 and photovoltaic panel 604-2, or to roof 602, by sewing, by welding, by using adhesive, by using stickers, by using screws, by using rivets, by using magnets, or by using hook and loop.

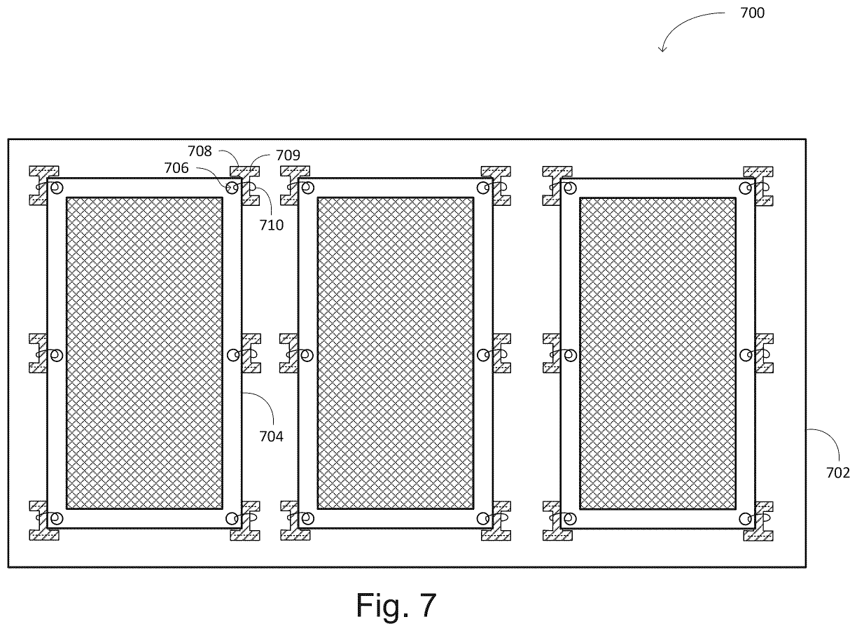

Reference is now made to FIG. 7, which may show photovoltaic panels attached to a roof of a truck, generally referenced 700. FIG. 7 shows a photovoltaic panel, such as photovoltaic panel 704, attached to a surface, such as a roof 702 of a trailer of a truck. According to the disclosure herein, securing ring, such as securing ring 708 may be attached to roof 702. In the example shown in FIG. 7, securing 708 is made of fabric (e.g., the same fabric coveting the frame of the trailer), and has a shape of the letter H. Securing ring 708 is attached to roof 702 at the stems of securing ring 708 as indicated by dotted line 709, and the bar of securing ring 708 forms a flexible ring. For example, securing ring 708 may be attached to roof by sewing, by welding, by using adhesive, by using stickers, by using screws, by using rivets, by using magnets, and/or by using Hook and loop. Photovoltaic panel 704 may comprise eyelets, such as eyelets 706, located at the edge of photovoltaic panel 706. Photovoltaic panel 704 may be attached to roof 702 by tying (e.g., using rope, cable, or cable tie) photovoltaic panel 704 to roof 702, such as by securing ring 708 and eyelet 706. According to another example, fasteners may be attached to roof 702, for securing photovoltaic panel 704 through eyelets 706.

One or more aspects of the disclosure may be embodied in computer-usable data and computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects of the disclosure, and such data structures are contemplated within the scope of computer executable instructions and computer-usable data described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus comprising a surface and one or more photovoltaic panels attached to the surface, wherein the surface is a flexible surface, and the one or more photovoltaic panels are attached to the surface by one or more of: sewing, welding, hook and loop fasteners, zippers, adhesive, belts, or speed tape.

2. The apparatus of claim 1, wherein the surface is made of fabric.

3. The apparatus of claim 2, further comprising a pocket connected to the fabric to receive the one or more photovoltaic panels.

4. The apparatus of claim 1, further comprising one or more pockets each for receiving therein a corresponding one of the one or more photovoltaic panels.

5. The apparatus of claim 1, wherein the one or more photovoltaic panels are attached to the surface with an overlap between the one or more photovoltaic panels.

6. The apparatus of claim 5, wherein an edge of a first photovoltaic panel overlaps an edge of a second photovoltaic panel.

7. The apparatus of claim 1, further comprising a cooling plate between the surface and the one or more photovoltaic panels.

8. The apparatus of claim 7, wherein the cooling plate allows air to flow between the surface and the one or more photovoltaic panels.

9. The apparatus of claim 7, wherein the cooling plate comprises an air intake opening between adjacent photovoltaic panels.

10. The apparatus of claim 1, further comprising a three-sided slotted frame, wherein a corresponding one of the one or more photovoltaic panels is inserted into the three-sided slotted frame.

11. The apparatus of claim 10, further comprising a stopper at a fourth side of the one or more photovoltaic panels.

12. The apparatus of claim 1, further comprising a striplining attached between two adjacent photovoltaic panels of the one or more photovoltaic panels.

13. The apparatus of claim 1, further comprising securing rings for tying the one or more photovoltaic panels to the surface.

14. The apparatus of claim 1, further comprising a transparent film attached to panel surfaces of the photovoltaic panels.
